(19) United States
(12) Patent Application Publication
(10) Pub. No.: US 2008/0312381 A1
(43) Pub. Date: Dec. 18, 2008

(54) Scorch Delay in Free-Radical-Initiated Vulcanization Processes

(75) Inventors: Maria Montserrat Alvarez Grima, Maastricht (NL); Auke Gerardus Talma, Bathmen (NL); Rabindra Nath Datta, Schalkhaar (NL); Jacobus Wilhelmus Noordermeer, Nieuwstadt (NL)

Correspondence Address: KENYON & KENYON LLP, ONE BROADWAY, NEW YORK, NY, 10004, US

(73) Assignee: STICHTING DUTCH POLYMER INSTITUTE, AB EINDHOVEN (NL)

(21) Appl. No.: 11/909,508

(22) PCT Filed: Mar. 20, 2006
(86) PCT No.: PCT/EP2006/060859

§ 371 Date: Jun. 11, 2008

(30) Foreign Application Priority Data
Mar. 24, 2005 (EP) 05075700.4

(51) Int. Cl. C08C 19/28; C08C 19/22; C08C 19/20

(52) U.S. Cl. 525/326.5; 525/332.7; 525/343

(57) ABSTRACT

The invention relates to a process to cross-link rubbers comprising the step of combining a rubber with an initiator capable of generating free radicals, a maleimide-type co-agent, and a sulfur donor, wherein said co-agent and said sulfur donor are two different chemicals.

The present invention relates to a free-radical-initiated vulcanization process of rubbers.

Peroxide-initiated vulcanization processes, wherein the peroxide is a source of free radicals, have long been known. Typically, peroxide-initiated processes are used rather than sulfur-cure processes, where the resulting cured rubber should have good aging resistance, a high processing temperature, good compression set and/or good colour stability, as in, for example, electrical insulation, hoses, belts, and seals. However, the peroxide-initiated process typically suffers from scorching. For example, when short vulcanization times or high processing temperatures are needed, while at the same time the rubber composition to be cured must fill a mould cavity, a delayed start of the curing process may be needed. A too fast start of the cure will result in a scorching problem. Various solutions have been proposed to prevent scorching.

For example, U.S. Pat. No. 6,277,925 teaches to use specific allyl compounds as scorch retarders in peroxide-based curing systems. Good scorch retarding agents are defined to be those agents of which the use results in a Ts2 which is 10% longer than the Ts2 measured with the same equipment and the same mixture, except that it does not contain the scorch retarding agent.

Similarly, U.S. Pat. No. 5,292,815 teaches the use of certain biscitraconimido compounds in combination with a radical scavenger to control scorch time in the peroxide vulcanization of rubber, while at the same time a good cross-link density and a good cross-linking time are still observed.

However, it was observed that for most if not all of the systems of the prior art a reduction of scorch is accompanied by a reduction in cross-link density. Hence, there is a continued need for alternatives and improved products in this field. More particularly, the rubber cross-linking industry is interested in curing systems that give the same or a more pronounced scorch delay while achieving the same or a better cross-linking density.

Surprisingly, we have found that the use of a specific curing system has resulted in a cross-linking process that shows improved scorch delay and equal or improved curing characteristics (in particular with respect to the cross-link density) in comparison with conventional processes and which can be used for a wide range of rubbers. Also, the resulting cross-linked rubbers surprisingly had improved properties compared to conventional peroxide-cured rubbers. The specific curing process comprises the step of combining a rubber with an initiator capable of generating free radicals, a maleimide-type co-agent, and a sulfur donor, wherein said co-agent and said sulfur donor are two different chemicals. Therefore, the invention relates to a rubber curing process wherein at least these three chemicals are used, compositions comprising mixtures of these three chemicals, and cross-linked rubber articles resulting from the process.

It is noted that EP-A-0 254 010 teaches to use a peroxide, an imidazole-type compound, and a sulfur donor for making rubber products with no surface tackiness when the cross-linking occurs in the presence of oxygen. Compositions according to the present invention are not disclosed or suggested.

U.S. Pat. No. 3,297,713 discloses the use of symmetrical dithiobis(N-phenylmaleimides) as vulcanizing agents for rubber. The rubbers being suitably cured are said to be natural and synthetic rubbers having high olefinic unsaturation. These thio-maleimides are tested in either peroxide or benzthiazyl disulfide-based vulcanization processes. The present invention allows the use of a wider range of maleimides and results in a process with better curing characteristics and an improved product.

### DETAILED DESCRIPTION

Unless otherwise indicated, all percentages, parts, ratios, etc. listed here are by weight. The term “phr” means “per hundred rubber” and stands for the amount in weight percent based on the weight of the rubber in the formulation. Furthermore, the scorching, or scorch safety, further abbreviated here as Ts2, is defined as the time it takes, after the start of the curing process, for the torque to reach a value of 0.2 Nm (2 dNm) above the minimum torque observed when the cross-linking is measured using a RPA 2000 rheometer from Alpha Technologies. The cross-link density or extent of cross-linking (ΔTorque) is the maximum torque (MH) minus the minimum torque (ML) as observed during curing in the rheometer. The optimum cure (referred to here as t90) is defined to be the time it takes, after the start of the curing process, to reach a torque that is 90% of the Delta Torque value.

The rubbers to be cross-linked according to the invention can be selected from a wider range than for many of the prior art processes. The term rubbers as used includes all polymers, or mixture of polymers, which can be cross-linked (vulcanized, cured) with a free radical-generating compound. Suitable rubbers are natural rubbers, butadiene rubbers, styrene-butadiene rubbers, chloroprene rubbers, isoprene rubbers, nitrile rubbers, such as acrylonitrile-butadiene rubbers, silicone rubbers, modified rubbers, such as silicone rubber modified with an ethylene-α-olefin rubber, polyurethane rubbers, as well as elastomeric and/or thermoplastic polymers. Preferred rubbers among these elastomeric and/or thermoplastic polymers are polyethylene and ethylene-containing copolymers, such as ethylene-α-olefin copolymers, ethylene-acrylic acid ester rubbers, ethylene-α-olefin rubbers, and ethylene-α-olefin-non-conjugated diene copolymers. The α-olefins mentioned in the ethylene-α-olefin copolymers and ethylene-α-olefin-non-conjugated diene copolymers are typically selected from, but not limited to, propene, 1-butene, 1-hexene, 1-decene, 1-heptene and the like. Typical non-conjugated diene species in the ethylene-α-olefin-non-conjugated dienes are 1,4-hexadiene, dicyclopentadiene, ethylidene-norbornene, methyl-norbornene, and vinyl-norbornene. Preferred rubbers used in the invention comprise one or more polymers selected from polyethylene, such as linear low density polyethylene, low density polyethylene, high density polyethylene, and chlorinated polyethylene, ethylene-propylene copolymers, ethylene-vinyl acetate copolymers, silicone elastomers, nitrile elastomers, chlorosulfonated polyethylene elastomer, polychloroprenes (such as neoprene®), chlorosulfonated polyethylene, and fluoroelastomers. More preferably, the rubber comprises a polymer containing ethylene, such as high density polyethylene (HDPE), low density polyethylene (LDPE), linear low density polyethylene (LLDPE), chlorinated polyethylene (CPE), ethylene vinyl acetate polymer (EVA), ethylene octene copolymers, ethylene hexene copolymers, ethylene butene copolymers, ethylene-propylene elastomer (EPM), and ethylene-propylene diene elastomer (EPDM). The most preferred rubbers to be cross-linked according to the invention are EPM and EPDM. All of the rubbers mentioned are commercially available.

The radical-generating compounds which can be used in accordance with the invention are typically selected from compounds with labile C—C, O—O, N—N, O—C bonds, but also could be other products that are precursors for free radicals, e.g., after excitation with radiation. Preferably, they are selected from compounds that are thermally labile, meaning that the free radical is produced upon heating the compound. Preferred thermally labile compounds are C—C initiators, azo-initiators, and peroxides. Preferred C—C initiators are 2,3-dimethyl-2,3-diphenyl butane (Perkadox® 30) and 3,4-dimethyl-3,4-diphenyl hexane (Perkadox® 58). Preferred peroxides are perketals, peresters, dialkyl peroxides, diacyl peroxides, trioxepane compounds of the following formula

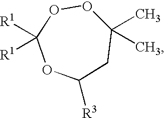

wherein R¹, R², and R³ are independently selected from hydrogen and a substituted or unsubstituted hydrocarbyl group, and cyclic ketone peroxides with a structure represented by the formulae I-III:

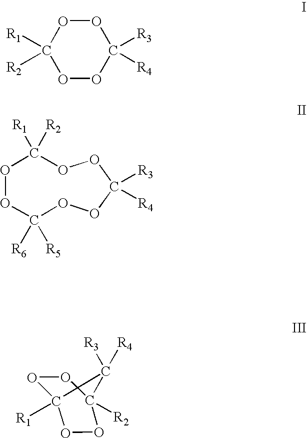

wherein R₁-R₆ are independently selected from the group consisting of hydrogen, C₁-C₂₀ alkyl, C₃-C₂₀ cycloalkyl, C₆-C₂₀ aryl, C₇-C₂₀ aralkyl, and C₇-C₂₀ alkaryl, which groups may include non-cyclic or branched alkyl moieties; and each of R₁-R₆ may optionally be substituted with one or more groups selected from C₁-C₂₀ alkyl, linear or branched, C₃-C₂₀ cycloalkyl, C₆-C₂₀ aryl, C₇-C₂₀ aralkyl, hydroxy, C₁-C₂₀ alkoxy, C₆-C₂₀ aryloxy, C₇-C₂₀ aralkoxy, C₇-C₂₀ alkaryloxy, R₁C(O)O—, R₁OC(O)—, halogen, carboxy, nitrile, and amido; or R₁/R₂, R₃/R₄ and R₅/R₆ may each, together with the carbon atom to which they are attached, form a 3 to 20 atom-membered cycloaliphatic ring which may optionally be substituted with one or more groups selected from C₁-C₂₀ alkyl, non-cyclic or branched, C₃-C₂₀ cycloalkyl, C₆-C₂₀ aryl, C₇-C₂₀ aralkyl, hydroxy, C₁-C₂₀ alkoxy, C₆-C₂₀ aryloxy, C₇-C₂₀ aralkoxy, C₇-C₂₀ alkaryloxy, R₁C(O)O—, R₁OC(O)—, halogen, carboxy, nitrile, and amido. Preferred azo-initiators and peroxides are those that have a half life of more than 1 hour at 100° C.

More preferred initiators are peroxides selected from: dialkyl peroxides, such as di-cumyl peroxide (Perkadox® BC), t-butyl cumyl peroxide (Trigonox® T), di-t-butyl peroxide (Trigonox® B), di(t-butyl peroxyisopropyl) benzene in the meta, para or mixed meta/para form (Perkadox® 14), 2,5-dimethyl 2,5-di(t-butyl peroxy) hexane (Trigonox® 101), 2,5 dimethyl 2,5-di(t-butyl peroxy) hexyne-3 (Trigonox® 145), t- butyl isopropyl cumyl peroxide, di-t-amyl peroxide (Trigonox® 201), and cumyl isopropyl cumyl peroxide; peroxy esters, such as: di(t-butyl peroxy)phthalate, t-butyl peroxy benzoate (Trigonox® C), t-butyl peroxy acetate (Trigonox® F), t-butyl peroxy-2-ethyl hexanoate (Trigonox® 21), t-butyl peroxy isopropyl carbonate (Trigonox® BPIC), t-butyl peroxy-2-methyl benzoate (Trigonox® 97), t-butyl peroxy laurate, t-butyl peroxy diethyl acetate (Trigonox® 27), t-butyl peroxy isobutyrate (Trigonox® 41), t-butyl peroxy-3,5,5-trimethylhexanoate (Trigonox® 42), t-amyl peroxy benzoate (Trigonox® 127), t-amyl peroxy acetate, and t-amyl peroxy 2-ethyl hexanoate (Trigonox® 121); peroxy ketals, such as ethyl 3,3-di(t-butyl peroxy) butyrate, ethyl 3,3-di(t-amyl peroxy) butyrate, n-butyl 4,4-di(t-butyl peroxy) valerate, 2,2-di(t-amyl peroxy) propane, 2,2-di(t-butyl peroxy) butane (Trigonox® D), 1,1-di(t-butyl peroxy) cyclohexane (Trigonox® 22), 1,1-di(t-butyl peroxy)-3,5,5-trimethyl cyclohexane (Trigonox® 29), and 1,1-di(t-amyl peroxy) cyclohexane; trioxepans, such as 3,3,5,7,7-pentamethyl-1,2,4-trioxepan (Trigonox® 311); and cyclic ketone peroxides, such as 3,6,9-triethyl-3,6,9-trimethyl-1,4,7-triperoxononane (Trigonox® 301).

The amount of peroxide typically used, based on the weight of the rubber, typically is from 0.02, preferably from 0.08, more preferably from 0.1% by weight (phr), up to 12, preferably up to 10, most preferably up to 5% by weight (phr).

The maleimide-type co-agent to be used is of the formulae IVa-d

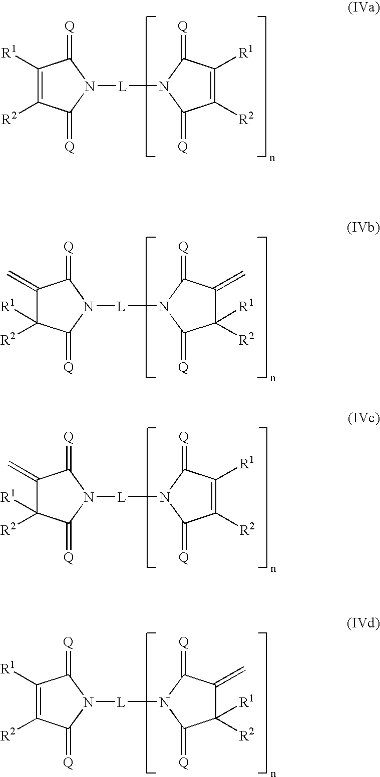

wherein each Q is independently selected from oxygen and sulfur, L is a n+1-valent bridging group, each R¹ and each R2 is independently selected from hydrogen, substituted or unsubstituted C₁₋₆ hydrocarbyl, or halogen. Optionally, the maleimide-type co-agent is added to the rubber in the form of a suitable precursor of the formula IVe

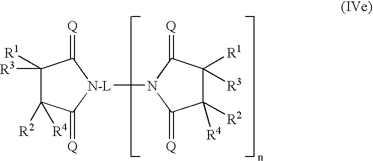

wherein R¹ and R² have the meaning presented above, R³ has the meaning defined for R¹, and R⁴, optionally together with R³,is a leaving group. Said leaving group must be suitable to form an endocyclic or exocyclic double bond before or during the cross-linking step. Suitable leaving groups are selected from the group consisting of F, Cl, Br, I, CN, OSO₂R₅, SpR₅, OR₅, OOR₅, OC(O)R₅, OS(O)R₅, SₚC(S)OR₆, NR₆R₇, N⁺R₆R₇R₈, SₚNR₆R₇, SpC(S)NR₆R₇, 2-mercaptobenzothiazolyl having one or more sulfur-bridging atoms, and which group is optionally substituted with R₆, (RO)₂P(O)Sₚ, (RS)₂P(O)Sp, (RO)₂P(S)Sₚ, (RS)₂P(S)Sₚ, phthalimido-Sₚ, cyclohexenyl, and which group is optionally substituted with R₆, and

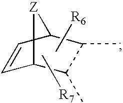

wherein R₅, R₆, and R₇ are independently selected from the group consisting of hydrogen, C₁-C₁₀ alkyl, C₃-C₁₈ cycloalkyl, C₃-C₁₈ polycycloalkyl, C₂-C₁₈ alkenyl, C₂-C₁₈ alkynyl, C₆-C₁₈ aryl, C₆-C₂₀ polyaryl, C₇-C₂₀ alkaryl, and C₇-C₂₀ aralkyl, and which groups may optionally contain one or more O, N, Si, P, S, B, F, Cl, Br, or I atoms, or one or more C(O), C(O)O, C(O)N, C(S)N, SS, SO₂, SO₃, SO₂N, SiO₂, SiO₃, C(O)NHC(O), CN, C=NH, N=NH, N=N, N=N(O), NHNH, NO₂, or oxirane groups; R₈ has the same meaning as R₅, R₆, and R₇ except hydrogen; Z is O or CH₂; and p is an integer from 1 to 4. For a more detailed survey on the effect of leaving groups reference may be had to a textbook of organic chemistry, on the basis of which the person of ordinary skill will be able to select a suitable leaving group of choice. See, for example, Advanced Organic Chemistry by J. March, 4th ed., John Wiley & Sons (i.e. pp. 205, 1005, and 1008), incorporated herein by reference. Preferred leaving groups for the purpose of the present invention are chloro, mesyl, 2-mercaptobenzothiazolyl, dibenzyl dithiocarbamoyl, diethyl dithiocarbamoyl, dimethyl dithiocarbamoyl, ethyloxy dithiocarboxy, benzyloxy dithiocarboxy, and 3,6-oxa-cyclohex-4-ene, as in the particularly preferred precursor compound of formula V

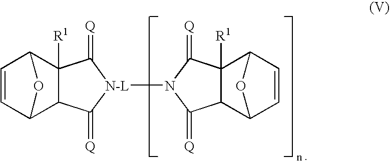

The bridging group L preferably is a substituted or unsubstituted, optionally sulfur, oxygen, silicium, and/or phosphor-containing, C1-6 aliphatic, cycloaliphatic, aromatic, or combined aliphatic and aromatic group. Examples of suitable groups L are phenyl and diphenyl-containing moieties, such as in N,N′-m-phenylene dimaleimide (BMI-MP) and N,N′-p-phenylene dimaleimide (BMI-PP), 4,4′-diphenyl ether dimaleimide, 4,4′-diphenyl (mono, di, tri, or poly)sulfide dimaleimide, 4,4′-diphenyl sulfone dimaleimide, 4,4′-diphenyl methane dimaleimide, 3,3′-diphenyl ether dimaleimide, 3,3′-diphenyl (mono, di, tri, or poly)sulfide dimaleimide, 3,3′-diphenyl sulfone dimaleimide, 3,3′-diphenyl methane dimaleimide, 4,4′-(2-dimethyl) diphenyl methane dimaleimide, 4,4′-(2-dimethyl) diphenyl ether dimaleimide, 4,4′-biphenylene dimaleimide, 4,4′-diphenyl isopropylidene dimaleimide, 3,4′-diphenyl isopropylidene dimaleimide, 1,4-(maleimide-4′-phenoxy) phenylene, 1,3-(maleimide-4″-phenoxy) phenylene, 4,4′-phenoxy diphenyl sulfone-4″-dimaleimide, and 4,4′-(maleimide-4″-phenoxy) diphenyl sulfone.

Most preferred are 4,4′-diphenyl methane dimaleimide, 4,4′-diphenyl (mono, di, tri, or poly)sulfide dimaleimide, N,N′-m-phenylene dimaleimide (BMI-MP), and N,N′-p-phenylene dimaleimide (BMI-PP).

The amount of maleimide-type co-agent typically used, based on the weight of the rubber, typically is from 0.1, preferably from 0.5, more preferably from 3% by weight (phr), up to 12, preferably up to 10, most preferably up to 5% by weight (phr).

The sulfur donor is different from the maleimide-type co-agent used and is selected from compounds of the formula Y-Sx-Y (VI), wherein x is, on average, 2 or more, and each Y atom is independently selected from C and N, and each Y is independently substituted with groups selected from any one or more of hydrogen, oxygen, sulfur, and any neutral substituted carbon, nitrogen or silicon-based groups, in order to obtain a neutral compound. For compounds of the formula wherein x is 2, the sulfur donors are preferably selected from compounds of the formula R³C(Q)—(S)₂—C(Q)R³, wherein Q has the meaning defined above, preferably S, and R³ is any neutral substituted carbon, nitrogen or silicon-based group. However, due to their greater efficiency, products of formula VI wherein x is, on average, greater than 3 are preferred. Examples of suitable sulfur donors are dithiodimorpholine, caprolactam disulfide, 2-morpholino-dithio-benzoth iazole, dipentamethylene thiuram tetrasulfide, dipentamethylene thiuram hexasulfide, N-oxydiethylene dithiocarbamyl-N′-oxydiethylene sulfonamide, bis(triethoxysilyl-propyl) tetrasulfide, tetrabenzyl thiuram disulfide and tetramethyl thiuram disulfide. The amount of sulfur donor that used, based on the weight of the rubber, typically is from 0.02, preferably from 0.08, more preferably from 0.1% by weight (phr), up to 12, preferably up to 10, most preferably up to 5% by weight (phr).

Other conventional rubber additives may also be employed in their usual amounts. For example, reinforcing agents or fillers such as carbon black, silica, clay, chalk, talc, aluminium hydroxide, magnesium hydroxide, and calcium carbonate may be included in the rubber composition. Other additives such as lubricants, tackifiers, waxes, antioxidants, pigments, UV-stabilization agents, antiozonants, blowing agents, nucleating agents, extender oils, e.g. paraffinic oils, voltage stabilizers, water tree retardants, metal deactivators, coupling agents, dyes, and colorants may also be included alone or in combination. If used, such additives are to be used in an amount sufficient to give the intended effect.

Before the actual cross-linking of the composition, the various ingredients are to be mixed thoroughly without cross-linking occurring. If the initiator is a thermally labile compound, this means that mixing is typically done at temperatures where the half life of the initiator is more than 0.5 hour, preferably more than 1 hour, even more preferably more than 2 hours. In practice, the temperature of the rubber is limited to 50 to 150° C. during the mixing phase. The mixing can be achieved in various ways, as is known to the skilled person. For instance, the components may be milled on a variety of apparatus including multi-roll mills, screw mills, continuous mixers, compounding extruders, and Banbury mixers, or dissolved in mutual or compatible solvents. When all of the solid components of the composition are available in the form of a powder, or as small particles, the compositions are most conveniently prepared by first making a blend of the components, such as in a Banbury mixer or a continuous extruder; and then masticating this blend on a heated mill, for instance a two-roll mill, and continuing with the milling until an intimate mixture of the components is obtained. Alternatively, a master batch containing the rubber and one or more antioxidants and, if desired, some or all of the other components, may be added to the mass of rubber. Where the rubber is not available in the powder form, the compositions may be made by introducing the rubber component to the mill, masticating it until it forms a band around one roll, after which a blend of the remaining components is added and the milling continued until an intimate mixture is obtained. The rolls, in the case of polyolefins, are preferably kept at a temperature which is in the range of about 80 to 120° C. and is below the rapid decomposition temperatures of the initiator component. The composition is removed from the mill in the form of a sheet and then brought into a form, typically dice-like pieces, suitable for subsequent processing.

After mixing, the composition is cross-linked upon the formation of free radicals by the initiator in conventional ways. Preferably, the rubber is cross-linked at temperatures from 80, more preferably 120, most preferably 140 up to 300° C., more preferably up to 200° C. in a period of 2 minutes up to 2 hours. The most common cross-linking temperatures are in the range of 160-200° .

For example, all of the components of the compositions of the present invention can be blended or compounded together prior to their introduction into an extrusion apparatus from which they are to be extruded such as at temperatures of about 120 to 160° C. for polyolefins. After being extruded, the compositions of the present invention are vulcanized at elevated temperatures of about 140° C. or greater, preferably about 180 to 200° C., using conventional vulcanizing procedures.

The rubber compositions can have various uses including, without limitation: tire compositions, such as tread, undertread, sidewall, wire skim, inner liner, and bead compounds; industrial rubber compositions, such as hoses, belts, tubes, engine mounts, shock absorbers and isolators, weather stripping, mouldings, and vehicle bumpers; and wire and cable, such as semi-conductor and insulating compounds.

### EXAMPLES

### Experimental

| Rubber | EPM/Keltan ® 13 | DSM Elastomers |
|---|---|---|
| Initiators | 1. Dicumyl peroxide | 1. Perkadox ® BC-40- |
| | 2. di(t-butyl)peroxy- | Bpd (Akzo Nobel) |
| | isopropyl) | 2. Perkadox ® 14 BC- |
| | benzene | 40-gr (Akzo Nobel) |
| Maleimide-type co-agent | 1. BMI-PP | 1. Acros |
| | 2. BMI-MP | 2. Akzo Nobel |
| Sulfur donors | 1. TBzTD | 1. Flexsys |
| | 2. DPTT | 2. Flexsys |
| | 3. DPTH | 3. Flexsys |
| | 4. TESPT/Si69 | 4. Degussa |
| Further additives | | |
| 1. Carbon black | 1. N550 | 1. Cabot |
| 2. Stearic acid | 2. | 2. Aldrich |
| 3. Paraffinic oil | 3. Sunpar ® 150 | 3. Sun Oil Cie |
| 4. Anti-oxidant | 4. BHT | 4. Aldrich |
| 5. Sulfur | 5. | 5. Merck |
| 6. co-agent | 6. TAC | 6. Akzo Nobel |
| 7. co-agent | 7. EDMA | 7. Akzo Nobel |

BMI-PP = N,N′-p-phenylene dimaleimide

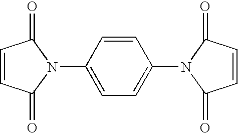

BMI-MP = N,N′-m-phenylene dimaleimide

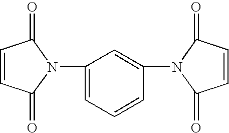

TBzTD = Tetrabenzyl thiuram disulfide

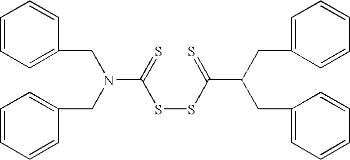

DPTT = Dipentamethylene thiuram tetrasulfide

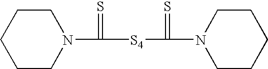

DPTH = dipentamethylene thiuram hexasulfide
TESPT = bis(triethoxysilyl-n-propyl) tetrasulfide

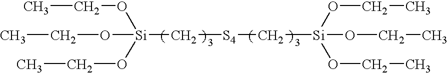

TAC = Triallyl cyanurate
EDMA = Ethylene dimethacrylate

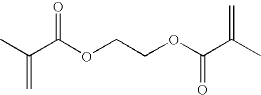

Mixing: For all rubber compositions being evaluated, first a masterbatch comprising 100 parts by weight (pbw) EPM, 60 phr carbon black, 1 phr stearic acid, and 45 phr paraffinic oil was prepared in a conventional way. Cross-linking ingredients (see tables) were added to this masterbatch on a Schwabenthan two-roll mill (friction 1:1.22, temperature 50-70° C., mixing time 10 minutes).

Cross-linking evaluation: The cross-linking was evaluated using a RPA 2000 from Alpha Technologies to determine: the delta torque or extent of cross-linking, being the maximum torque (MH) minus the minimum torque (ML); scorch safety (Ts2), being the time to reach 2 dNm above minimum torque (ML); and optimum cure time (t90), being the time to reach 90% of the delta torque above minimum in accordance with method ISO 6502 (Rubber-Measurement of vulcanization characteristics with rotorless curemeters).

Samples for mechanical testing of cross-linked rubber: Samples were prepared by cross-linking rubber compositions by compression moulding in a Wickert press at 160° C. for a period of time which was twice the t90 time. The samples were 2 mm thick, in accordance with method ISO 37.

Evaluation of cross-linked rubber: The cross-linked rubber was die-cut into dumb-bells and tested in a Zwick tensile tester, in accordance with ISO 37.

### Comparative examples A-C and Example 1

In all these and the following examples the ingredients as given in the table (the amounts being in pbw) were added to 206 pbw of the masterbatch.

Example

| | | A | B | 1 | C |
|---|---|---|---|---|---|
| Peroxide | Dicumyl peroxide | 2.4 | 2.4 | 2.4 | 2.4 |
| Co-agent | BMI-PP | 4 | 4 | 4 | 4 |
| Anti oxidant | BHT | 0 | 0.06 | 0 | 0 |
| Sulfur donor | TBzTD | 0 | 0 | 4.1 | 0 |
| Sulfur | S₈ | 0 | 0 | 0 | 0.1 |

| | ΔTorque | Ts2 | t₉₀ | Tens. Str. | | Mod 100 | Mod 200 | Mod 300 |
|---|---|---|---|---|---|---|---|---|
| | (dNm) | (min) | (min) | (MPa) | E. Break (%) | (MPa) | (MPa) | (MPa) |
| A | 4.3 | 0.53 | 10.8 | 8.4 | 339 | 1.6 | 4.34 | 7.53 |
| B | 3.3 | 0.54 | 8.0 | 7.9 | 453 | 1.18 | 2.79 | 5.13 |
| 1 | 3.5 | 1.47 | 33.6 | 9.3 | 743 | 1.17 | 2.25 | 3.75 |
| C | 4.87 | 0.65 | 16.4 | 9.5 | 356 | 1.73 | 4.67 | 8.03 |

From these results it is clear that only in Example 1 a delayed start of the cure is observed. So only this combination leads to an improved scorch. The extent of cross-linking (ΔTorque) in this example is not optimal yet. Further, it follows from the torque, tensile strength, and elongation at break that the cross-linked product of Example 1 has superior properties. Also it follows that sulfur as such is not suitable to be a sulfur donor in the process according to the invention.

### Examples 2-4

Another sulfur donor was evaluated, using various amounts, in Examples 2-4

Example

| | | A | 2 | 3 | 4 |
|---|---|---|---|---|---|
| Peroxide | Dicumyl peroxide | 2.4 | 2.4 | 2.4 | 2.4 |
| Co-agent | BMI-PP | 4 | 4 | 4 | 4 |
| Sulfur Donor | DPTT | 0 | 1.9 | 0.96 | 3.85 |

| | ΔTorque | Ts2 | t₉₀ | Tens. Str. | | Mod 100 | Mod 200 | Mod 300 |
|---|---|---|---|---|---|---|---|---|
| | (dNm) | (min) | (min) | (MPa) | E. Break (%) | (MPa) | (MPa) | (MPa) |
| A | 4.3 | 0.53 | 10.8 | 8.4 | 339 | 1.6 | 4.34 | 7.53 |
| 2 | 5.2 | 1.47 | 25.1 | 9.1 | 789 | 0.95 | 1.7 | 2.92 |
| 3 | 6.07 | 1.51 | 30.3 | 11.1 | 555 | 1.42 | 3.4 | 6.04 |
| 4 | 2.61 | 1.13 | 14.18 | 3.6 | 1170 | 0.65 | 0.82 | 1.10 |

Clearly, the use of a preferred compound like DPTT, wherein x=4, in combination with peroxide and maleimide-type co-agent, gives both good scorching and good cross-linking over a wide concentration range. The result of Example 4 shows that for a certain sulfur donor the amount to be used is to be optimized, since too high amounts can result in a lowering of the extent of cross-linking of the rubber. Again, the torque, elongation at break, and tensile strength show that the cross-linked rubbers according to the invention have superior properties.

### Comparative example D and Example 5

Example 2 was repeated, except that varying amounts of the co-agent were used, with the following results.

Example

| | | D | 5 |
|---|---|---|---|
| Peroxide | Dicumyl peroxide | 2.4 | 2.4 |
| Co-agent | BMI-PP | 2 | 2 |
| Sulfur Donor | DPTT | 0 | 1.9 |

| | ΔTorque | Ts2 | t₉₀ | Tens. Str. | | Mod 100 | Mod 200 | Mod 300 |
|---|---|---|---|---|---|---|---|---|
| | (dNm) | (min) | (min) | (MPa) | E. Break (%) | (MPa) | (MPa) | (MPa) |
| D | 3.15 | 0.54 | 8.4 | 8.5 | 515 | 1.12 | 2.59 | 4.84 |
| 5 | 3.24 | 1.15 | 16.8 | 6.5 | 1035 | 0.78 | 1.21 | 1.85 |

It is shown that the amount of co-agent is to be optimized on a case-by-case basis.

### Examples 6 and 7

Example 2 was repeated, except that other sulfur donors were used. The following results were obtained.

| | | A | 2 | 6 | 7 |
|---|---|---|---|---|---|
| Peroxide | Dicumyl peroxide | 2.4 | 2.4 | 2.4 | 2.4 |
| Co-agent | BMI-PP | 4 | 4 | 4 | 4 |
| Sulfur donor | DPTT | 0 | 1.9 | 0 | 0 |
| | DPTH | 0 | 0 | 1.7 | 0 |
| | TESPT | 0 | 0 | 0 | 4.0 |

| | ΔTorque | Ts2 | t₉₀ | Tens. Str. | | Mod 100 | Mod 200 | Mod 300 |
|---|---|---|---|---|---|---|---|---|
| | (dNm) | (min) | (min) | (MPa) | E. Break (%) | (MPa) | (MPa) | (MPa) |
| A | 4.3 | 0.53 | 10.8 | 8.4 | 339 | 1.6 | 4.34 | 7.53 |
| 2 | 5.14 | 1.47 | 25.1 | 9.1 | 789 | 0.95 | 1.7 | 2.92 |
| 6 | 5.05 | 1.39 | 25.9 | 9.2 | 679 | 1.16 | 2.31 | 3.92 |
| 7 | 4.06 | 0.91 | 34.8 | 10.5 | 497 | 1.43 | 3.49 | 6.20 |

These results show that various sulfur donors can be used.

### Example 8 and Comparative Examples E-I

Example 2 was repeated, except that other co-agents were used in the presence or absence of a sulfur donor. The following results were obtained.

| | | A | 2 | E | 8 | F | G | H | I |
|---|---|---|---|---|---|---|---|---|---|
| Peroxide | Dicumyl peroxide | 2.4 | 2.4 | 2.4 | 2.4 | 2.4 | 2.4 | 2.4 | 2.4 |
| Co-agent | BMI-PP | 4 | 4 | 0 | 0 | 0 | 0 | 0 | 0 |
| | BMI-MP | 0 | 0 | 4 | 4 | 0 | 0 | 0 | 0 |
| | TAC | 0 | 0 | 0 | 0 | 2.5 | 2.5 | 0 | 0 |
| | EDMA | 0 | 0 | 0 | 0 | 0 | 0 | 3 | 3 |
| Sulfur Donor | DPTT | 0 | 1.9 | 0 | 1.9 | 0 | 1.9 | 0 | 1.9 |

| | ΔTorque | Ts2 | t₉₀ | Tens. Str. | | Mod 100 | Mod 200 | Mod 300 |
|---|---|---|---|---|---|---|---|---|
| | (dNm) | (min) | (min) | (MPa) | E. Break (%) | (MPa) | (MPa) | (MPa) |
| A | 4.3 | 0.53 | 10.8 | 8.4 | 339 | 1.6 | 4.34 | 7.53 |
| 2 | 5.14 | 1.47 | 25.1 | 9.09 | 789 | 0.95 | 1.7 | 2.92 |
| E | 3.24 | 0.50 | 7.2 | 7.02 | 465 | 1.06 | 2.45 | 4.52 |
| 8 | 4.99 | 1.57 | 22.6 | 9.3 | 719 | 1.02 | 1.96 | 3.46 |
| F | 2.72 | 0.57 | 21.1 | 8.36 | 625 | 0.93 | 2.0 | 3.69 |
| G | 1.73 | 0.79 | 17.5 | 4.8 | 1192 | 0.61 | 0.8 | 1.1 |
| H | 2.03 | 0.69 | 13.8 | 7.22 | 843 | 0.8 | 1.35 | 2.25 |
| I | 1.77 | 0.69 | 15.2 | 5.04 | 1198 | 0.65 | 0.87 | 1.25 |

Clearly, the use of conventional co-agents outside the claimed range is not effective in improving scorch and cross-linking, whereas Examples E and 8 prove that also for a co-agent like BMI-MP the combination of ingredients as claimed is needed in order to achieve the desired results. Again, the torque, tensile strength, and elongation at break of the cross-linked rubbers according to the invention are superior to those of the other rubbers.

### Examples 9-10 and Comparative examples J-K

Examples 1 and A were repeated, except that another initiator was used. The following results were obtained.

| | | A | 1 | J | 9 | K | 10 |
|---|---|---|---|---|---|---|---|
| Peroxide | Dicumyl peroxide | 2.4 | 2.4 | 0 | 0 | 0 | 0 |
| | Perkadox ® 14 | 0 | 0 | 3 | 3 | 1.5 | 1.5 |
| Co-agent | BMI-PP | 4 | 4 | 4 | 4 | 4 | 4 |
| Sulfur Donor | DPTT | 0 | 1.9 | 0 | 1.9 | 0 | 1.9 |

| | ΔTorque | t₀₂ | t₉₀ | Tens. Str. | | Mod 100 | Mod 200 | Mod 300 |
|---|---|---|---|---|---|---|---|---|
| | (dNm) | (min) | (min) | (MPa) | E. Break (%) | (MPa) | (MPa) | (MPa) |
| A | 4.3 | 0.53 | 10.8 | 8.4 | 339 | 1.6 | 4.34 | 7.53 |
| 1 | 5.14 | 1.47 | 25.1 | 9.1 | 789 | 0.95 | 1.7 | 2.92 |
| J | 5.10 | 0.55 | 14.8 | 7.7 | 276 | 1.94 | 5.25 | — |
| 9 | 6.95 | 1.87 | 31.4 | 10.6 | 478 | 1.74 | 4.12 | 6.88 |
| K | 4.40 | 0.81 | 20.1 | 9.4 | 365 | 1.64 | 4.47 | 7.84 |
| 10 | 5.16 | 1.77 | 30.1 | 8.5 | 803 | 0.95 | 1.69 | 2.82 |

The results show that also for another peroxide the same effects are observed.

### Examples 11-15 and Comparative example L

To 206 pbw of the masterbatch, 2.4 pbw dicumyl peroxide, 4 pbw BMI-MP, and varying amounts of DPTT were added. The effect of the amount of DPTT on the compression set and Shore A hardness is indicated in the table below.

| | | Compression Set (%) | | | |
|---|---|---|---|---|---|
| | DPTT (phr) | 23° C. | 70° C. | 150° C. | Shore A harness |
| L | 0 | 16.6 | 22.1 | 30.0 | 45.4 |
| 11 | 0.10 | 15.2 | 18.9 | 26.3 | 46.6 |
| 12 | 0.50 | 13.9 | 16.3 | 26.3 | 48.2 |
| 13 | 0.70 | 14.5 | 17.0 | 33.1 | 49.5 |
| 14 | 0.96 | 15.0 | 20.5 | 41.3 | 49.3 |
| 15 | 1.90 | 20.4 | 33.6 | 79.7 | 45.6 |

The development of the tensile strength, elongation at break, Modulus 100, and Modulus 200 during aging of these samples at 150° C. is indicated in the following table. It can be seen that rubber cross-linked according to the present invention has a higher aging stability that rubber cross-linked in the absence of a sulfur donor.

| | | Aging | | | | |
|---|---|---|---|---|---|---|
| | DPTT | time | Tens. | E. Break | Mod 100 | Mod 200 |
| | (phr) | (days) | Str. (MPa) | (%) | (MPa) | (MPa) |
| L | 0 | 0 | 7.02 | 465.1 | 1.06 | 2.45 |
| | | 3 | 6.07 | 428.4 | 1.10 | 2.34 |
| | | 5 | 4.37 | 353.0 | 1.01 | 2.15 |
| | | 7 | 3.60 | 299.5 | 1.06 | 2.23 |
| | | 10 | 1.91 | 174.5 | 1.06 | 2.16 |
| 11 | 0.10 | 0 | 7.70 | 425.6 | 1.28 | 3.29 |
| | | 3 | 6.99 | 403.8 | 1.30 | 2.96 |
| | | 5 | 5.50 | 346.3 | 1.17 | 2.68 |
| | | 7 | 4.41 | 302.6 | 1.23 | 2.74 |
| | | 10 | 2.71 | 214.2 | 1.16 | 2.50 |
| 12 | 0.50 | 0 | 8.47 | 381.8 | 1.53 | 3.86 |
| | | 3 | 8.91 | 419.5 | 1.42 | 3.43 |
| | | 5 | 7.39 | 376.7 | 1.41 | 3.29 |
| | | 7 | 5.91 | 349.94 | 1.35 | 2.97 |
| | | 10 | 3.70 | 272.2 | 1.16 | 2.52 |
| 13 | 0.70 | 0 | 9.15 | 455.9 | 1.47 | 3.50 |
| | | 3 | 8.41 | 416.6 | 1.49 | 3.40 |
| | | 5 | 7.68 | 406.3 | 1.39 | 3.16 |
| | | 7 | 7.96 | 414.6 | 1.46 | 3.20 |
| | | 10 | 3.65 | 280.6 | 1.17 | 2.46 |
| 14 | 0.96 | 0 | 9.68 | 583.6 | 1.47 | 3.40 |
| | | 3 | 8.91 | 479.6 | 1.37 | 3.00 |
| | | 5 | 7.33 | 431.5 | 1.34 | 2.85 |
| | | 7 | 6.71 | 400.0 | 1.30 | 2.71 |
| | | 10 | 4.23 | 344.0 | 1.15 | 2.30 |

1. Process to cross-link rubbers comprising the step of combining a rubber with:
an initiator capable of generating free radicals,
a maleimide-type co-agent, and
a sulfur donor,
wherein said co-agent and said sulfur donor are two different chemicals.

2. The process according to claim 1 wherein the rubber is selected from the group consisting of natural rubbers, butadiene rubbers, styrene-butadiene rubbers, chloroprene rubbers, isoprene rubbers, nitrile rubbers, silicone rubbers, modified rubbers, such polyurethane rubbers, elastomeric polymers, thermoplastic polymers, elastomeric and thermoplastic polymers, and mixtures thereof.

3. The process according to claim 1 wherein the initiator is selected from the group consisting of compounds with labile C—C, O—O, N—N, and O—C bonds, and mixtures thereof.

4. The process according to claim 1 wherein the maleimide-type co-agent is selected from the group consisting of compounds of the formulae IVa-e 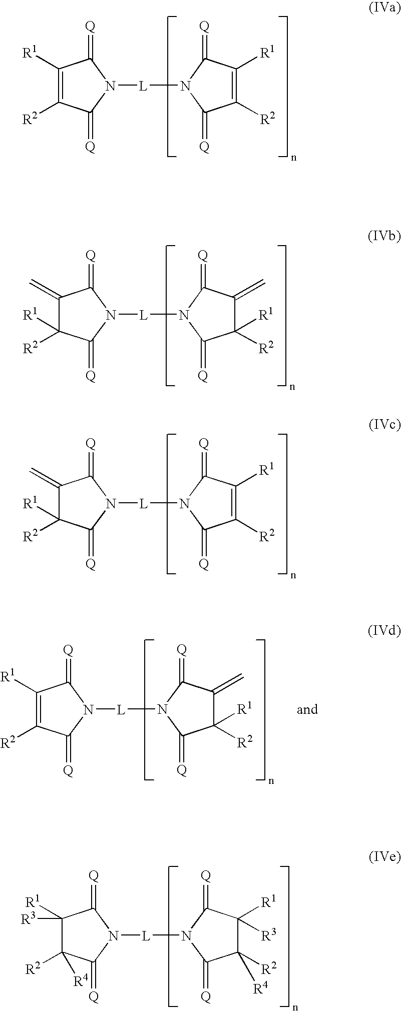
wherein each Q is independently selected from oxygen and sulfur, L is a n+1-valent bridging group, each R¹ is independently selected from hydrogen, substituted or unsubstituted C₁₋₆ hydrocarbyl, or halogen, and each R² is independently selected from hydrogen or hydrocarbyl, R³ has the meaning as defined for R¹, and R⁴, optionally together with R³, is a leaving group.

5. The process according to claim 4 wherein the maleimide-type co-agent is selected from the group consisting of N,N′-p-phenylene dimaleimide, N,N′-m-phenylene dimaleimide, and products of the formula 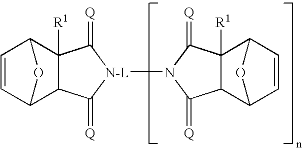
wherein R¹, Q, L, and n have the meaning given in claim 4.

6. The process according to claim 1 wherein the sulfur donor is one or more compounds of the formula Y-Sx-Y (VI), wherein x is, on average, 2 or more, and each Y atom is independently selected from C and N, and each Y is independently substituted with groups selected from any one or more of hydrogen, oxygen, sulfur, and any neutral substituted carbon, nitrogen or silicon-based groups, in order to obtain a neutral compound.

7. (canceled)

8. A composition comprising a rubber, an initiator capable of generating free radicals, a maleimide-type co-agent, and a sulfur donor, wherein said co-agent and said sulfur donor are two different chemicals.

9. A cross-linked rubber obtained by the process of claim.

10. The process according to claim 2 wherein the nitrile rubbers are acrylonitrile-butadiene rubbers, and the modified rubbers are silicone rubber modified with an ethylene-α-olefin rubber.

11. The process according to claim 2 wherein the initiator is selected from the group consisting of compounds with labile C—C, O—O, N—N, and O—C bonds, and mixtures thereof.

12. The process according to claim 2 wherein the maleimide-type co-agent is selected from the group consisting of compounds of the formulae IVa-e 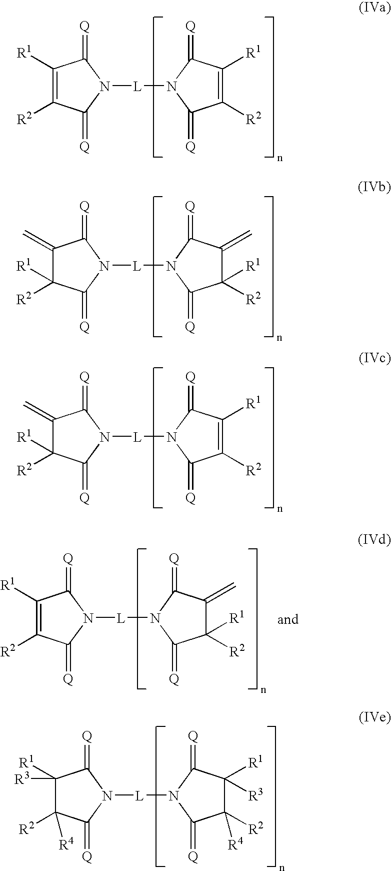
wherein each Q is independently selected from oxygen and sulfur, L is a n+1-valent bridging group, each R¹ is independently selected from hydrogen, substituted or unsubstituted C₁₆ hydrocarbyl, or halogen, and each R² is independently selected from hydrogen or hydrocarbyl, R³ has the meaning as defined for R¹, and R⁴, optionally together with R³, is a leaving group.

13. The process according to claim 11 wherein the maleimide-type co-agent is selected from the group consisting of compounds of the formulae IVa-e 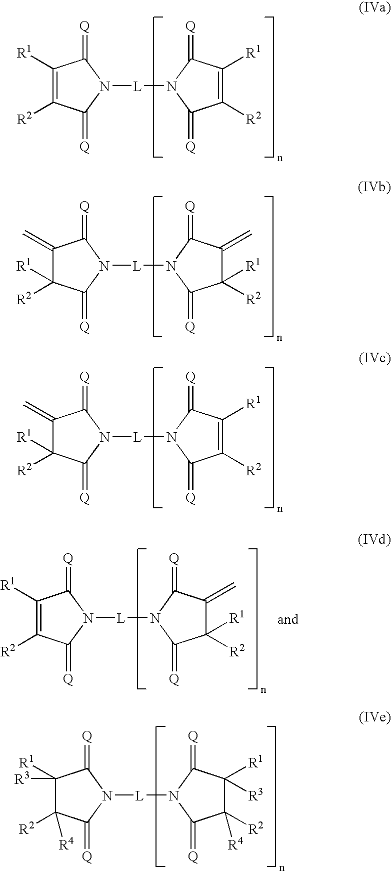
wherein each Q is independently selected from oxygen and sulfur, L is a n+1-valent bridging group, each R¹ is independently selected from hydrogen, substituted or unsubstituted C₁₆ hydrocarbyl, or halogen, and each R² is independently selected from hydrogen or hydrocarbyl, R³ has the meaning as defined for R¹, and R⁴, optionally together with R³, is a leaving group.

14. The process according to claim 2 wherein the sulfur donor is one or more compounds of the formula Y-Sx-Y (VI), wherein x is, on average, 2 or more, and each Y atom is independently selected from C and N, and each Y is independently substituted with groups selected from any one or more of hydrogen, oxygen, sulfur, and any neutral substituted carbon, nitrogen or silicon-based groups, in order to obtain a neutral compound.

15. The process according to claim 13 wherein the sulfur donor is one or more compounds of the formula Y-Sx-Y (VI), wherein x is, on average, 2 or more, and each Y atom is independently selected from C and N, and each Y is independently substituted with groups selected from any one or more of hydrogen, oxygen, sulfur, and any neutral substituted carbon, nitrogen or silicon-based groups, in order to obtain a neutral compound.

16. The composition according to claim 8 wherein the rubber is selected from the group consisting of natural rubbers, butadiene rubbers, styrene-butadiene rubbers, chloroprene rubbers, isoprene rubbers, nitrile rubbers, silicone rubbers, modified rubbers, polyurethane rubbers, elastomeric polymers, thermoplastic polymers, elastomeric and thermoplastic polymers, and mixtures thereof.

17. The composition according to claim 16 wherein the initiator is selected from the group consisting of compounds with labile C—C, O—O, N—N, and O—C bonds, and mixtures thereof.

18. The composition according to claim 17 wherein the maleimide-type co-agent is selected from the group consisting of compounds of the formulae IVa-e 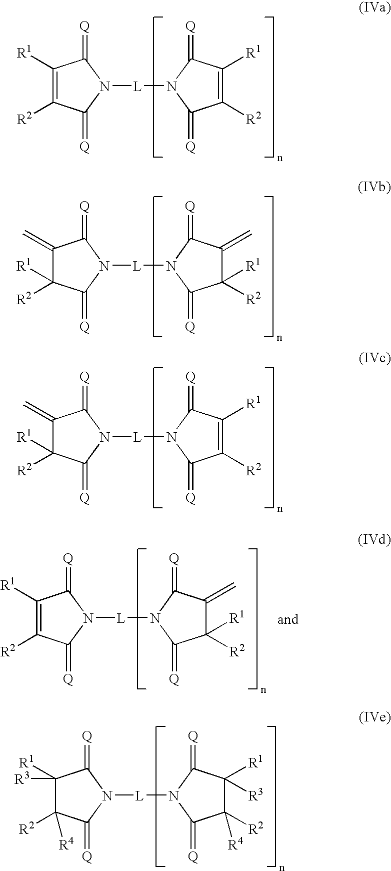
wherein each Q is independently selected from oxygen and sulfur, L is a n+1-valent bridging group, each R¹ is independently selected from hydrogen, substituted or unsubstituted C₁₋₆ hydrocarbyl, or halogen, and each R² is independently selected from hydrogen or hydrocarbyl, R³ has the meaning as defined for R¹, and R⁴, optionally together with R³, is a leaving group.

19. The composition according to claim 18 wherein the sulfur donor is one or more compounds of the formula Y-Sx-Y (VI), wherein x is, on average, 2 or more, and each Y atom is independently selected from C and N, and each Y is independently substituted with groups selected from any one or more of hydrogen, oxygen, sulfur, and any neutral substituted carbon, nitrogen or silicon-based groups, in order to obtain a neutral compound.

20. The composition according to claim 8 wherein the maleimide-type co-agent is selected from the group consisting of compounds of the formulae IVa-e 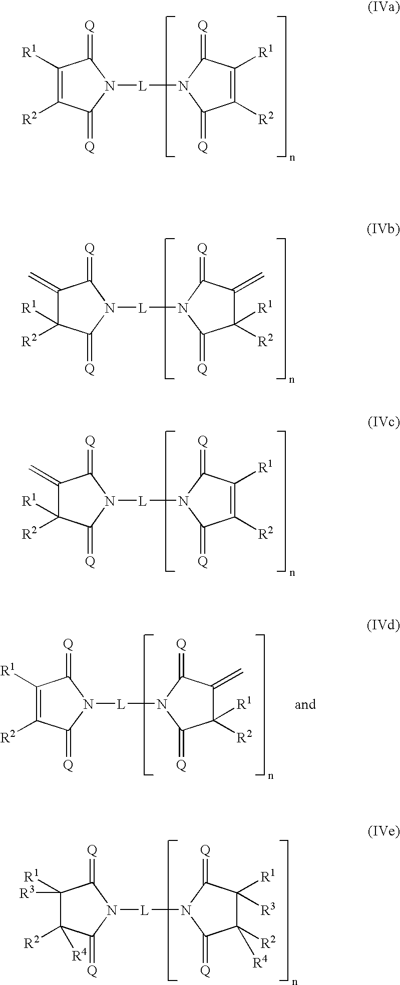
wherein each Q is independently selected from oxygen and sulfur, L is a n+1-valent bridging group, each R¹ is independently selected from hydrogen, substituted or unsubstituted C₁₋₆ hydrocarbyl, or halogen, and each R² is independently selected from hydrogen or hydrocarbyl, R³ has the meaning as defined for R¹, and R⁴, optionally together with R³, is a leaving group.

21. The composition according to claim 8 wherein the sulfur donor is one or more compounds of the formula Y-Sx-Y (VI), wherein x is, on average, 2 or more, and each Y atom is independently selected from C and N, and each Y is independently substituted with groups selected from any one or more of hydrogen, oxygen, sulfur, and any neutral substituted carbon, nitrogen or silicon-based groups, in order to obtain a neutral compound.
